(19) United States
(12) Patent Application Publication
(10) Pub. No.: US 2011/0263338 A1
(43) Pub. Date: Oct. 27, 2011

(54) GAME DEVICE AND GAME CONTROL METHOD

(75) Inventors: Satoshi Horie, Tokyo (JP); Atsushi Ueno, Tokyo (JP); Toru Mori, Tokyo (JP); Yuichiro Murotsuka, Tokyo (JP); Masahiro Mihara, Tokyo (JP)

(73) Assignee: SEGA CORPORATION, Tokyo (JP)

(21) Appl. No.: 13/141,981

(22) PCT Filed: Nov. 9, 2009
(86) PCT No.: PCT/JP2009/069063

§ 371 Date: Jun. 23, 2011

(30) Foreign Application Priority Data
Dec. 26, 2008 (JP) 2008-332048

(51) Int. Cl. A63F 13/10

(52) U.S. Cl. 463/43

(57) ABSTRACT

To provide a game device that can reduce the size of the device and can execute the simulation of a match game scene based on an operation input by a game player.

A field panel 9 imitating a field of a sporting event, card holding stages 10 that are arranged in the locations indicating the positions of players in the sporting event on the field panel 9, and holding card 11 in a raised state, a card information reading means for reading card information recorded on the cards 11 held by the card holding stages 10, and a game execution control means for controlling the execution of a game are provided. Further, the game execution control means includes a means for controlling, based on the card information read by the card information reading means, the execution of the simulation of the match game scene, which is displayed on the touch panel 6 based on the operation by the game player, to be a predetermined number of times that is set in advance.

### TECHNICAL FIELD

The present invention relates to a game device which reads information recorded on play items, such as cards, and performs a game while displaying game contents on a display device, and to a game control method.

### BACKGROUND ART

Conventionally, as for a game device using cards as play items, i.e., trading cards, a game device for soccer is known. As for such a game device, for example, a card game device has been proposed which is described in the PLT1 described below.

When starting a game by operating the card game device, first, a game player playing a game arranges, on a transparent card arrangement panel forming the game device, player cards to be used in the game such that the back surfaces thereof contact an upper surface of the card arrangement panel. Subsequently, a game execution control means of the game device performs control of starting the game by activating an imaging means 13a, which is installed inside the card arrangement panel, so as to read card information recorded on the back surfaces of the player cards, and creating game control data, such as performance values of the players constituting a team, based on the read card information.

Then, upon starting of the game, when the game player moves the player card arranged on the card arrangement panel while sliding the player card on the card arrangement panel, the game execution control means performs control of detecting the movement of the player card and also moving the position of a player in a game scene. Thus, the game player can give an instruction such as a formation.

Additionally, in game devices for sporting events, a game device has been proposed which includes a means for effect displaying, a battle (appearance) scene of characters appearing in the game as a simulation image based on an input operation by the game player. As for such kind of game devices, for example, the inventions have been proposed which are described in PLT2 and PLT3 described below.

PLT2 proposes a baseball game device that allows the game player to operate a pitcher. The baseball game device described in PLT2 enables to perform a simulation game by including a pitching motion setting means for setting a pitching motion of the pitcher in accordance with an input operation by the game player, a storage means for storing the pitching motion, a ball speed calculating means for calculating the ball speed of a ball pitched by the pitcher based on the pitching motion, and a simulating means for performing a match simulation between the pitcher and a hitter with the pitching performance including the ball speed.

PLT3 proposes a game device that allows a game player to operate the movement of a pitcher. The game device described in PLT3 includes a storage means for storing data related to attributes of a plurality of baseball players who are registered in advance, a situation setting means for randomly setting a situation by using the baseball players, a pitching means for realizing pitching performance in accordance with the operation by the game player and the attributes of the pitcher, a simulating means for simulating, under the above-described set situation, the battle between the pitcher and a hitter based on the attributes of the hitter and the pitching performance, and a scene clearing means for requesting setting of a new situation every time a predetermined range is met.

### CITATION LIST

### Patent Literature

PLT1: Japanese Patent Application Laid-Open Publication No. 2007-665
PLT2: Japanese Patent Application Laid-Open Publication No. 2001-129250
PLT3: Japanese Patent Application Laid-Open Publication No. 2001-137549

### SUMMARY OF INVENTION

### Technical Problem

The invention described in the above-described PLT1 is a card game device using the player cards, which serve as trading cards. When starting a game, it is necessary for the game player to arrange the player cards to be used in one game on the card arrangement panel, and register the card information recorded on the player cards in the game execution control means. Regarding the operation of arranging the player cards to be used in the one game on the card arrangement panel, it is necessary to place the faces (for example, the back surfaces) of the player cards, on which the card information is recorded, on the card arrangement panel such that each of the player cards does not overlap with each other. Hence, in order to arrange a large number of the player cards corresponding to the first team on the card arrangement panel when starting the game such as a soccer game, the need arises to inevitably increase the surface area of the card arrangement panel, resulting in a large-size card game device. As a result, there is a problem in that the manufacturing costs of the card game device are increased.

The baseball game devices described in the above-described PLT2 and PLT3 set the pitching motion of the pitcher in accordance with the input operation by the game player. Additionally, the game execution control means includes a means for executing the match simulation between the pitcher and the hitter based on the set pitching motion and the pitch specified by the game player. However, it is not a card game device that performs a baseball game by using the cards of the players who belong to a preferred team of the game player.

Therefore, the present invention is made for providing a game device which solves the above-described problems of the conventional game devices. An object is to reduce the space of an area in the game device required for reading the card information, by providing a means for reading, before starting a game, the card information recorded on the cards to be used in the game in a state where the cards are raised, in the game device using the cards such as trading cards.

Another object is to provide a game device which can end a play time of one game (one match) within a predetermined time period or can reduce the play time, by providing a means for controlling the number of times of the match scenes of the game which allows operation of characters by an input operation from an operation means by the game player based on the read card information and the like to be a predetermined number of times.

### Solution to Problem

In order to solve the above-described problems, a game device according to the invention described in claim 1 is a game device including a game execution control means for controlling progress of a game in accordance with card information read from a card and an operation input signal input from an operation means including a touch panel, the game device including:

a field panel provided above the touch panel and imitating a game field;

a plurality of card holding stages that are arranged in respective positions on the field panel indicating positions of a plurality of characters in the game field and hold the card in a raised state; and

a card information reading means for reading card information recorded on the card held by the card holding stages,

wherein the game execution control means controls the progress of the game, based on the card information read by the card information reading means.

Additionally, the invention described in claim 2 depends from the game device described in claim 1, and the game execution control means includes:

a simulation means for controlling, based on the card information read by the card information reading means, progress of a game by making a character corresponding to the card information participate therein, and simulating a game development from a start until an end of the game;

an evaluation means for calculating evaluation information for each appearance scene of the character in a simulation result;

a selection means for selecting, based on the evaluation information, a specific scene that allows an operation of the character by the operation means from the appearance scene of the character; and

a specific scene simulation means for simulating a game development in a specific scene based on an operation input signal from the operation means in the specific scene selected by the selection means,

wherein the simulation means simulates again a game development from a specific scene until an end of a game, based on a simulation result by the specific scene simulation means.

Further, the invention described in claim 3 depends from the game device described in claim 2, and the game execution control means includes a means for controlling the number of times of execution of the specific scene simulation means to be a predetermined number of times that is set in advance.

In addition, the invention described in claim 4 depends from the game device described in any one of claim 1 to claim 3, and the game execution control means includes:

a character-specific ability database that is information stored in a storage means for each character corresponding to the card information, and registers in advance an ability value of the character with respect to a game execution;

a condition setting parameter that increases or decreases the ability value of the character; and

a parameter value increasing/decreasing process means for increasing or decreasing, based on the condition setting parameter, the ability value in the game of the character corresponding to the card information read by the card information reading means.

Additionally, the invention according to claim 5 depends from the game device described in any one of claim 1 to claim 4, and the game execution control means includes a card placement reconfirmation means for determining, before execution of the specific scene simulation means, whether or not the card, corresponding to the card information read by the card information reading means, is held by the card holding stage, and

the parameter value increasing/decreasing means decreases the condition of a character corresponding to the card that is determined, by the card placement reconfirmation means, as not being held by the card holding stage.

Further, a game control method according to the invention described in claim 6 is a game control method in a game device including a storage means, an operation means including a touch panel, a field panel imitating a game field, a plurality of card holding stages that are arranged in respective positions on the field panel indicating positions of a plurality of characters on the game field and hold a card in a raised state, a card information reading means for reading the card information recorded on the card held by the card holding stage, and a game execution control means for controlling progress of a game, the game control method including:

a card information reading step for causing a game execution control means to read and store, in the storage means, the card information of the card held by the card holding stage; and

a game execution control step for controlling progress of a game in accordance with the card information stored in the storage means in the card information reading step and an operation input signal input from the operation means including the touch panel.

Additionally, the invention described in claim 7 depends from the game control method described in claim 6, and a game execution control means includes:

a simulation step for simulating, based on the card information read by the card information reading step, a game development from a start until an end of a game in which a character corresponding to the card information participates;

an evaluation step for calculating evaluation information for each appearance scene of the character in a result of the simulation step;

a selection step for selecting, based on the evaluation information calculated in the evaluation step, a specific scene that allows an operation of the character by the operation means from the appearance scene of the character; and

a specific scene simulation step for simulating a game development in the specific scene based on an operation input signal from the operation means in the specific scene selected in the selection step,

wherein the simulation step simulates again a game development from a specific scene until an end of a game, based on a simulation result in the specific scene simulation step.

In addition, the invention described in claim 8 depends from the game control method described in claim 7, and the number of times of execution of the specific scene simulation step is controlled to be a predetermined number of times that is set in advance.

Further, the invention according to claim 9 depends from the game control method described in any one of claim 6 to claim 8, and the game execution control means executes: a character-specific ability database that is information stored in the storage means for each character corresponding to the card information, and registers in advance an ability value of the character with respect to a game execution; a condition setting parameter that increases or decreases the ability value of the character; and a parameter value increasing/decreasing process step for increasing or decreasing, based on the condition setting parameter, the ability value in the game of the character corresponding to the card information read by the card information reading means.

Additionally, the invention described in claim 10 depends from the game control method described in any one of claim 6 to claim 9, and the game execution control means executes a card placement reconfirmation step for determining, before execution of the specific scene simulation step, whether or not the card, corresponding to the card information read by the card information reading means, is held by the card holding stage, and

the parameter value increasing/decreasing step decreases the condition of a character corresponding to the card that is determined, by the card placement reconfirmation step, as not being held by the card holding stage.

It should be noted that “game” in claims refers to operating the characters arranged in the game field by the game player, for example, simulation of games of sporting events, and simulation of battles based on wars. “From a start until an end of a game” refers to the start until the end of, for example, a game of a sporting event. Additionally, as for sporting events, sports are appropriate in which teams composed of a plurality of players play against each other, such as baseball, soccer, American football, and volleyball. Further, the above-described position refers to the fielding position of a player in baseball, or one or both of an offense position and a defense position of a player in soccer and volleyball.

### ADVANTAGEOUS EFFECTS OF INVENTION

The game device according to the present invention can achieve the following effects.

The card holding stages are provided that, when reading the card information stored in cards, such as a plurality of player cards, to be used in a game when starting the game, read the cards in the raised state. Therefore, it is possible to reduce the surface area of the field panel on which the card holding stages are provided. Hence, compared to a conventional card game device, it is possible to reduce the size of the shape of the device including the housing of the game device.

The game execution control means provided in the game device of the present invention controls, based on the card information read by the card information reading means, the number of times of execution of the simulation of the specific scene executed based on the operation by the game player to be the predetermined number of times that is set in advance. Hence, it is possible to end the play time of one game by the game player within a predetermined period of time.

### BRIEF DESCRIPTION OF THE DRAWINGS

FIG. 1 is a perspective view showing a structure of a game device according to one embodiment of the present invention;

FIG. 2 is a perspective view showing a structure of a card holding stage shown in FIG. 1;

FIG. 3 is a diagram for explaining a positional relationship between a card and an imaging means located in a sensor housing part of the card holding stage when the card is placed on and held by a card placing part of the card holding stage;

FIG. 4 is a diagram showing a state where, in a field panel to which the card holding stage shown in FIG. 2 is arranged, player cards are placed in a raised manner on the card holding stage;

FIGS. 5 are diagrams showing examples of structures of the surfaces of a player card, wherein (a) shows a front surface of the card, and (b) shows an exemplary printed display of a back surface;

FIG. 6 is a block diagram showing a structure of a control device provided in the game device shown in FIG. 1;

FIG. 7 is a diagram for explaining an exemplary data structure of a player-specific ability database stored in a storage device of the control device shown in FIG. 6;

FIG. 8 is a diagram showing an exemplary structure of a game execution control program provided in the control device shown in FIG. 6;

FIG. 9 is a flowchart showing an example of a procedure for controlling the progress of a game by the game execution control program provided in the control device;

FIG. 10 is likewise a flowchart showing the example of the procedure for controlling the progress of the game by the game execution control program provided in the control device;

FIG. 11 is likewise a flowchart showing the example of the procedure for controlling the progress of the game by the game execution control program provided in the control device;

FIG. 12 is a diagram showing an exemplary screen displayed on a touch panel shown in FIG. 1;

FIG. 13 is likewise a diagram showing an exemplary screen displayed on the touch panel shown in FIG. 1; and

FIG. 14 is likewise a diagram showing an exemplary screen displayed on the touch panel shown in FIG. 1.

### DESCRIPTION OF EMBODIMENTS

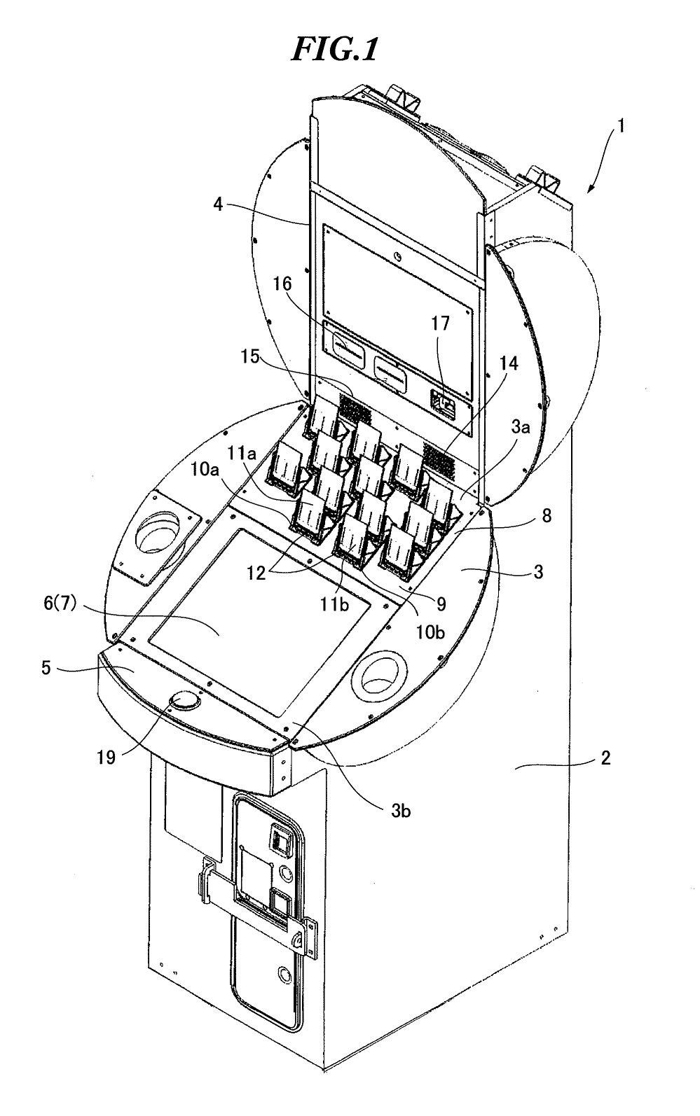

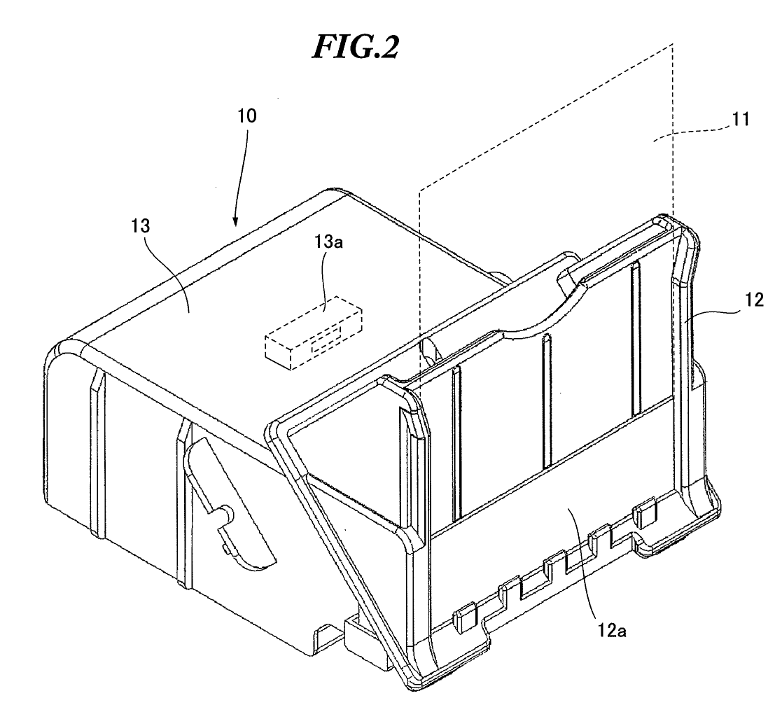

Hereinafter, a description will be given of the best mode for carrying out the invention with reference to the drawings. FIG. 1 is a diagram showing one embodiment of a game device of the present invention, and is a perspective view for explaining a structure of a front portion of a housing of the game device. Additionally, FIG. 2 is a perspective view showing a structure of a card holding stage arranged on a field panel shown in FIG. 1. It should be noted that, in the following description, the game device shown in FIG. 1 is explained as a game device for playing a baseball game. Further, as for the baseball game played in the game device, it is possible for a game player to enjoy a powerful game, for example, when a game is performed by using trading cards of players who belong to actual baseball teams (baseball club).

### [Structure of Game Device]

As shown in FIG. 1, a front side portion (the side from which a game player performs an operation) of a housing 2 of a game device 1 includes an adequately inclined table part 3, and a panel part 4 provided to extend in a vertical direction from an upper end portion 3a of the table part 3.

A liquid crystal display device 7 with a function of a touch panel 6, is arranged in a lower portion of the table part 3. A display surface of the touch panel 6 (hereinafter, the touch panel and the liquid crystal display device 7 are collectively and simply referred to as “the touch panel 6”) is fixed to the table part 3 such that the inclined angle of the display surface becomes substantially same as the inclined angle of the table part 3. Additionally, the touch panel 6 serves as an operation means for inputting various kinds of game execution instructions by directly touching a display screen with a finger, while the game player is playing the game. A pressure type, an electrostatic capacity type or the like can be adopted as an element for the touch panel 6. Further, the table part 5 is provided with an action (determination) button 19.

A card information reading unit 8 is provided on the upper surface of the table portion 3 and in the upper portion (on the further side when seen from the game player) than the touch panel 6. As shown in FIG. 1, a field panel field panel 9, having the substantially same inclined angle as the table portion 3, is formed on an upper surface of the card information reading unit 8. The field panel 9 is arranged to form a surface which is substantially the same as the inclined surface of the table portion 3.

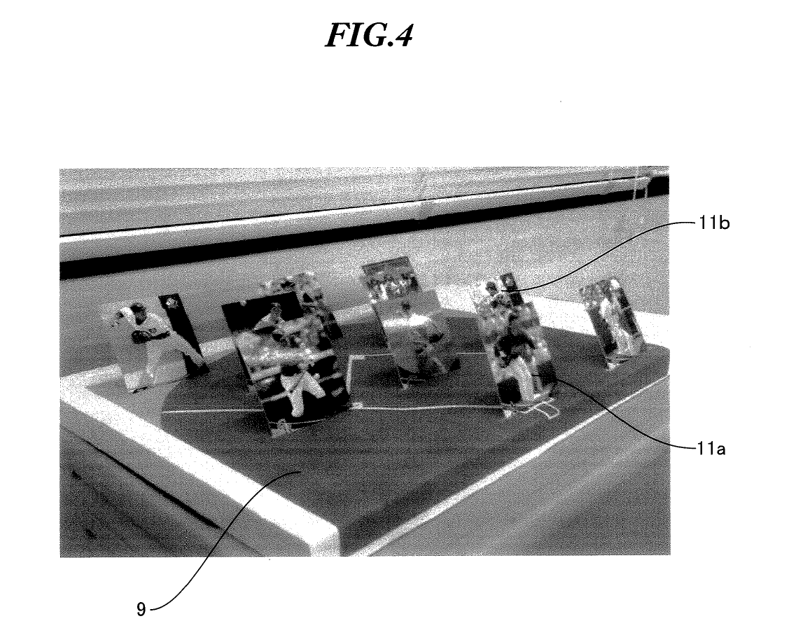

The field panel 9 includes a function for representing a field of a sporting event, i.e., a baseball-like field in this embodiment. For example, as shown in FIG. 4, bases such as a home base, foul lines in the right and left direction and the like, which imitates a baseball ground are illustrated on a surface of the field panel 9.

Additionally, as shown in FIG. 1, a plurality of card holding stages 10a, 10b, 10c, . . . are arranged on the field panel 9 and each of which is fixed to field panel 9, which imitates a baseball field. The card holding stages 10a, 10b, 10c, . . . serve as means for placing and holding, when the game player plays a game on the game device 1, each selected one of player cards 11a, 11b, 11c, . . . of one team which the game player owns in a raised state, and for holding the player cards 11 so as to read the card information recorded on these player cards in a state where the player cards are raised by a card information reading means, which is described later.

It should be noted that, in the following description, the card holding stages 10a, 10b, 10c, . . . are described as “the card holding stages 10” when the card holding stages 10a, 10b, 10c, . . . are collectively explained. Further, the player cards 11a, 11b, 11c, . . . are described as “the player cards 11” when the player cards 11a, 11b, 11c, . . . are collectively explained.

The positions for providing the respective card holding stages 10 on the baseball-field-like field panel 9 are, for example, the positions indicating the nine fielding positions (positions), the position indicating DH (designated hitter) which is set in the vicinity of the home base, the positions outside the right foul line indicating backup players, and the like. As for the card holding stages 10 for the backup players, for example, three stages are provided for three backup players. Therefore, 13 card holding stages 10a, 10b, . . . are provided on the field panel 9 shown in FIG. 1.

FIG. 2 is a perspective view showing an exemplary structure of the card holding stage 10. The card holding stage 10 includes a card placing part 12 for inserting the player card 11 therein and placing and holding the inserted player card 11 in a raised state, a sensor housing part 13, an imaging means 13a which is housed in the sensor housing part 13 and formed by an imaging element, such as a CMOS sensor or a CCD, for reading information (hereinafter referred to as “the card information”) recorded on the player card 11 placed on the card placing part 12, a light emitting diode (LED) 13b, a lens (not shown) and the like. Further, as shown in FIG. 2, an opening 12a is provided in a lower end portion of the card placing part 12, and the opening 12a communicates with the inside of the sensor housing part 13.

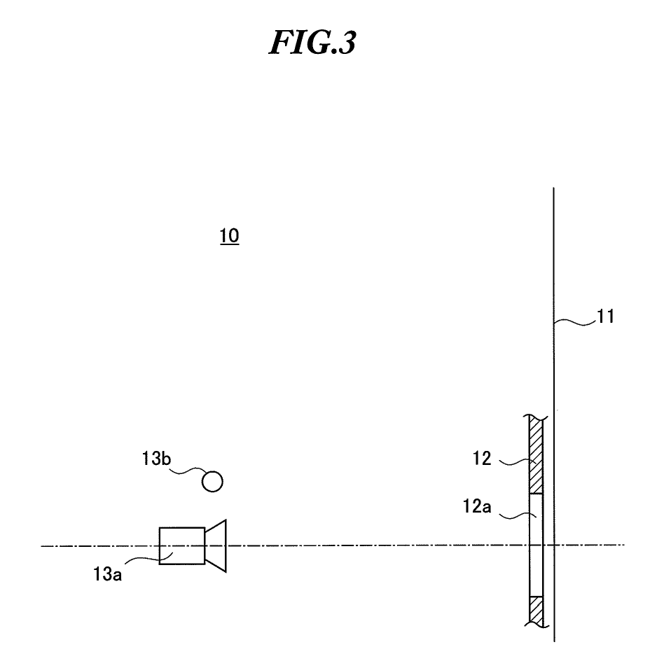

Additionally, when the imaging means 13a, the opening 12a, and the card information recorded on the player card 11 are arranged as shown in FIG. 3, it becomes possible for the imaging means 13a, which is housed in the sensor housing part 13, to image the card information recorded on the back surface of the player card 11 inserted into the card placing part 12, for example, the card information recorded on the lower portion of the back surface, via the opening 12a. On this occasion, the light emitting diode 12b is used to illuminate the card information recorded on the player card 11, so that the imaging means 12a can read the card information. It should be noted that the imaging means 13a including the above-described CMOS image sensor and the like, and a card information reading program P6, which is described later, constitute the card information reading means.

Further, as shown in FIG. 1, the card placing part 12, which forms the card holding stage 10 (10a, 10b, . . . ), is arranged on the upper surface side of the field panel 9, and the sensor housing part 13 is arranged in the position below the field panel 9, that is, inside the card information reading unit 8. Additionally, when the game player inserts the player card 11 into the card placing part 12 of the card holding stage 10, the front surface of the player card 11, on which the photograph of a player is printed, faces the front side of the housing 2.

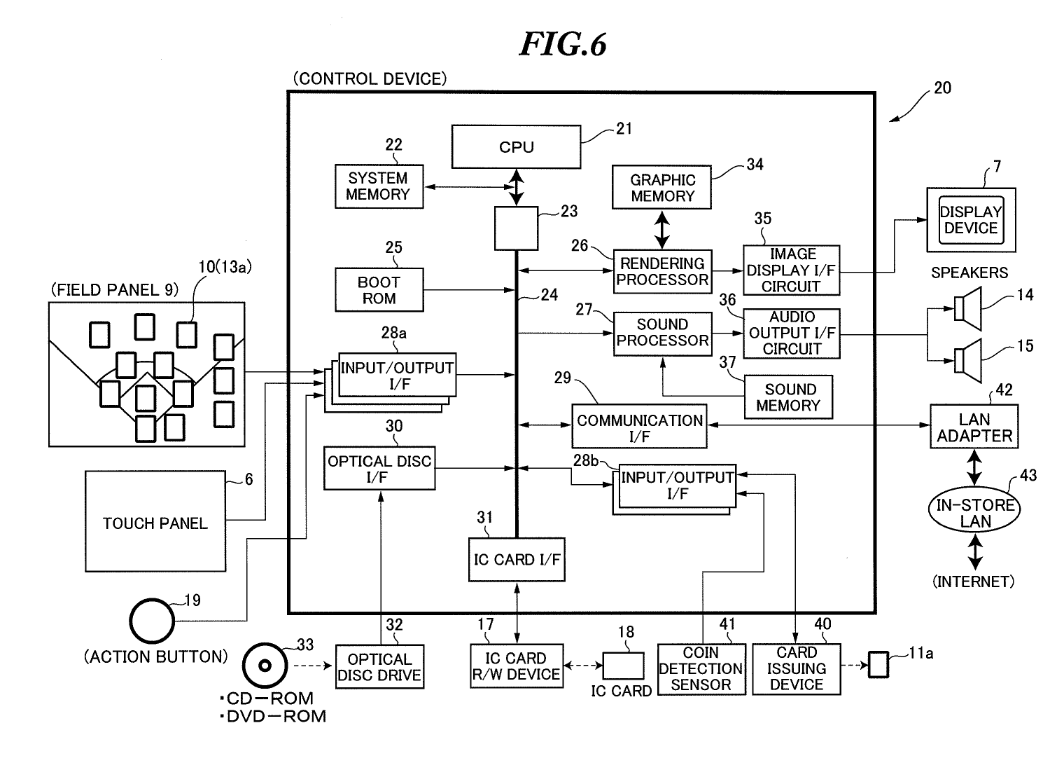

In FIG. 1, speakers 14 and 15, an issuing opening 16 of a card issuing device 40 (see FIG. 6) for issuing player cards to the game player when one game ends, and a read/write device (IC card R/W device) 17 for an IC card 18 (see FIG. 6) are provided in a lower portion of the panel part 4. The IC card 18 is an IC card which is sold to the game player when playing the game by using the game device 1. By inserting the IC card 18 into the IC card R/W device 17 when starting the game, it is possible to save various kinds of data, and to read the saved data. For example, it becomes unnecessary to perform various kinds of settings every time the game player plays the game, by saving the setting data of a team in the IC card 18, such as a lineup of the team for the game played by the game player.

As for the data items saved in the IC card 18, the number of times the card is used, the number of times the card is updated and the like are stored as the information related to the IC card itself. Additionally, the name of a team used by the game player, the number of times of wins/losses as the results of playing games (for each season/in total), the number of times of reaching playoffs, the number of times of winning the league championships, the number of times of winning the World Series, the number of times of executing strategies, the number of times of successful strategies, the number of points and the like are stored as team information for playing the game. The hitting order, the fielding positions, the IDs of registered players, various kinds of scores as the results of playing games for registered players are stored as information of the players who belong to the team.

Further, the maximum value is set for the number of times of usage of the IC card 18, for example, up to 100 games (plays).

### [Structure of Card]

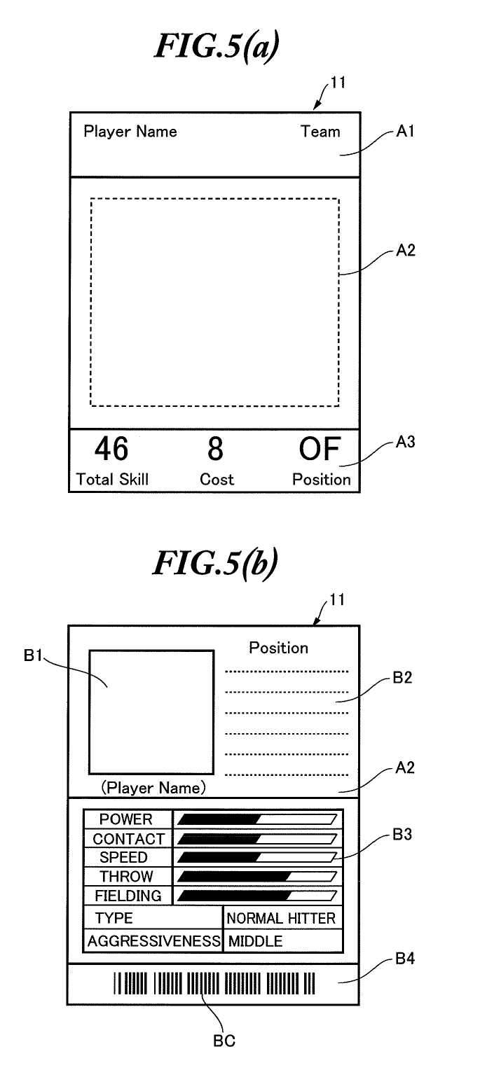

Then, a description is given of the cards (player cards) 11 used when the game player plays the game. FIGs. 5 are diagrams showing exemplary structures of the front surface and the back surface of the player card 11: FIG. 5(a) shows the front surface; and FIG. 5(b) shows the back surface. It should be noted that, as for the player cards 11, it is possible to use sheets of paper or the like having a predetermined thickness, coated with a vinyl, and conventionally used as the trading cards.

As shown in FIG. 5(a), a baseball team (team) name and a player name of a character corresponding to the player card 11 are recorded (printed) on an area A1 in the vicinity of an upper end portion of the front surface of the player card 11. Similarly, a photograph of the player is printed in an area A2 in the center portion. Further, the value of total skill (Total Skill), the value of cost, a code representing a position which is the basic fielding position of the player are printed on an area A3 in a lower end.

The above-described total skill value is a numeric value for indicating the ability value of a player. In the case of an outfielder, among predetermined ability parameter items which are set for indicating the ability of the player, the total skill value indicates a total value of parameter values of, for example, the following five ability parameter items: “POWER (power to hit ball away)”; “CONTACT (ability to hit ball with bat)”; “SPEED (running speed)”; “THROW (arm strength and accuracy of passing)”; and “FIELDING (catching ability)”. In the case of a pitcher, a total value of parameter items is shown which relate to predetermined other ability parameter items. Further, the parameter value with respect to the ability parameter item which is set for each player in advance is registered in a character-specific ability database (DB1), which is described later.

Additionally, as shown in FIG. 5(b), for example, a face photograph of the player is printed in an area B1, and character information for introducing the player is printed in an area B2, which is on the right side of the face photograph, of the back surface of the player card 11. Further, the value of total skill of the player shown on the front surface, and the above-described five ability parameter items, constituting the value of total skill, are each shown by a graph to indicate the magnitude of the parameter value.

A bar-code (BC) indicating unique player identification information, serving as the card information for identifying the player (character) corresponding to the player card 11, is recorded (printed) on an area B4, which is a lower end portion of the back surface of the player card 11. The bar-code (BC) is formed by a numeric value of a predetermined number of digits or by a numeric value and English character(s), and is imaged by the imaging means 13a which the above-described card holding stage 10 includes. It should be noted that the bar-code (BC) printed on the card 11 may be printed by using an ink which is visible when seen by human eyes. However, the bar-code (BC) printed on the card 11 may be printed by using an ink which is invisible when seen by human eyes, and a method may be adopted which emits an infrared light on the printed bar-code from the LED 13b or the like, and performs imaging by the imaging means 13a including the CMOS image sensor and the like.

Additionally, the above-described cost is a numeric value regarding ranking information of the player which is set in advance for each player. The more popular the player is, or the higher the ability of the player is, the higher the set value is, which is the cost to be consumed when using the player in the game. For example, eight levels of cost values are set.

### [Structure of Control Device]

Next, a description is given of a structure of a control device with which the game device 1 of this embodiment controls the proceeding of the game. FIG. 6 is a diagram showing an example of a hardware structure of a control device 20 which the game device 1 includes. The control device 20 is formed by a control substrate mounting a CPU, various kinds of ICs and interface (I/F) circuits and the like, and is located in a predetermined position within the housing 2.

A CPU 21 shown in FIG. 6 is connected to a system memory 22 and a bus arbiter 23 via a bus line. The system memory 22 is a storage means for storing a game program (game execution control program) for executing in the game device 1, a work area used by the game execution control program for controlling the execution of the game, and various kinds of reference data (player ability database and the like), and a non-volatile memory, which does not delete the stored contents even when the power of the game device 1 is turned off, is used.

The bus arbiter 23 is a circuit which manages setting of the usage right of a bus line with respect to usage requests of the bus line from the CPU, the I/F circuits and the like, which are connected to a single bus line 24. As shown in FIG. 6, a boot ROM (BOOT ROM) 25, a rendering processor 26, a sound processor 27, an input/output I/Fs 28a and 28b, a communication I/F 29, an optical disc I/F 30, an IC card I/F 31 and the like are connected to the common bus line 24.

The above-described boot ROM 25 is a ROM storing an IPL (Initial Program Loader), which is a loader program initially executed when the power of the game device is turned on (ON), or when a reset button is pressed. The IPL is a program for performing a process of activating an optical disc drive 32 via the optical disc I/F circuit 30, and reading and storing, in the system memory 22, the game program (game execution control program) recorded on an optical disc 33. Hence, for example, when the game device 1 is manufactured and shipped to a game arcade, the IPL is activated when the power of the game device 1 is turned on, and the game execution control program recorded on the optical disc 33 is loaded to the system memory 22. In this manner, it is possible to play the game by operating the game device 1.

The rendering processor 26 is a processor which performs, based on numeric value data for creating image data, a process of generating the image data such as three-dimensional images and the like. The image data created through the process by the rendering processor 26 is temporarily stored in the graphic memory 34, and displayed on the touch panel 6 as two-dimensional game image via the image display I/F circuit 35 based on control by the CPU 21.

The sound processor 27 is a processor which performs, based on the control by the CPU 21, a process of outputting data related to sound and sound effects stored in the sound memory 37 to the speakers 14 and 15 via the audio output I/F circuit 36 as the sound effects and audio for effects in the game.

The input/output I/F 28a is connected to the imaging means 13a such as each CMOS image sensor or the like arranged in the card holding stage 10 of the field panel 9, the touch panel 6, and the action button 19. Additionally, the input/output I/F 28b is connected to the card issuing device 40 and the coin detection sensor 41. The card issuing device 40 is a device for issuing a new player card 11a to the game player, when one game ends. The coin detection sensor 41 is a sensor that is provided in a coin insertion device, and detects inserted coin(s) when the game player plays the game.

The communication I/F 29 is connected to the in-store LAN 42 of the game arcade via the LAN adapter 42. Additionally, the in-store LAN 42 is connected to the Internet communication network. Further, the in-store LAN 42 may be connected to an arcade server, a plurality of game devices 1, and a game device for performing another game. When such an in-store LAN system is built, it is possible to perform a match game with a game player in the arcade or a game player in another game arcade by utilizing the Internet with the use of the game device 1 according to this embodiment. In addition, the IC card I/F 31 shown in FIG. 6 is connected to the IC card R/W device 17.

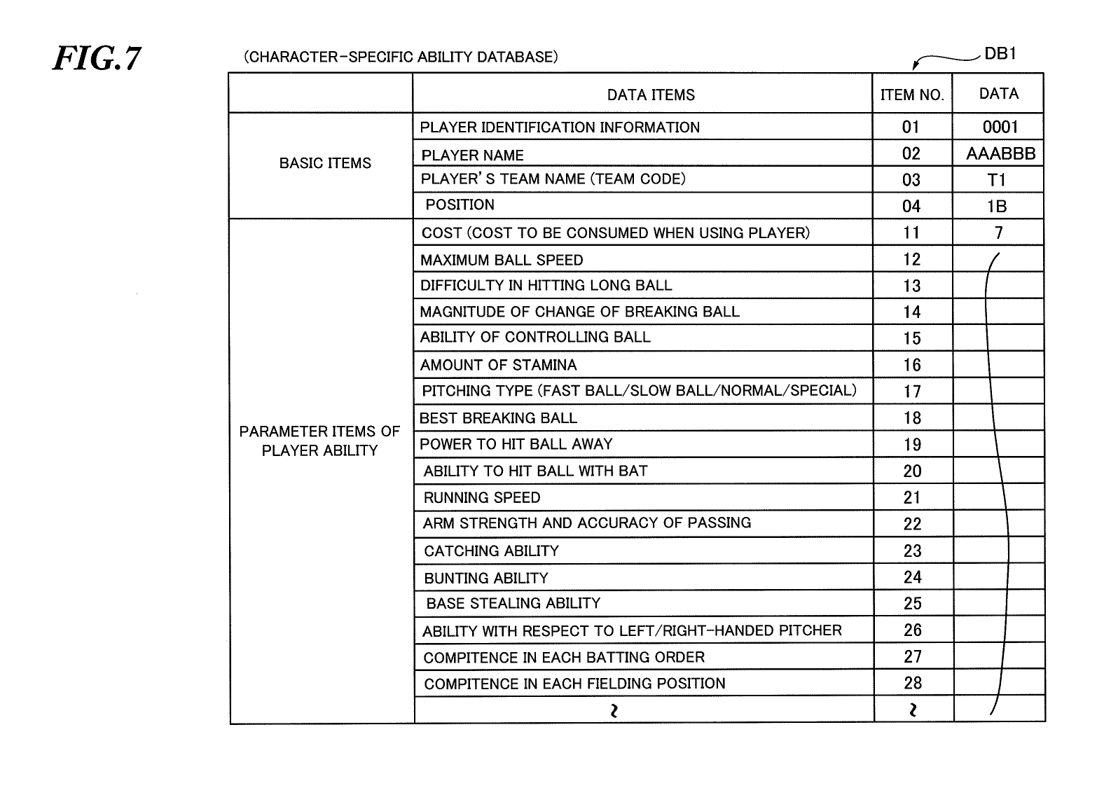

The system memory 22 of the game device 1 of this embodiment stores the character-specific ability database (DB1), which stores data related to data items shown in FIG. 7 for each set of identification information of the players (characters). The character-specific ability database (DB1) is a database storing data which is referred to when the game execution control program controls the execution of one game, and when conducting a process of performing a simulation of hitting or pitching by a player, based on an operation input signal generated through operating, by the game player, an operation means formed by the touch panel 6 or the action button 19, with respect to a picked-up match game scene, which is described later.

As shown in FIG. 7, the character-specific ability database (DB1) registers item numbers for identifying basic information related to the player, such as the player name of the player and the name of the team (baseball team) to which the player belongs, and parameter values which are set for the respective item numbers and identify various parameter items indicating abilities of the player.

These parameter items include, as shown in FIG. 7, the parameter items related to the pitcher, such as the cost, the maximum ball speed, . . . and the like, and the parameter items related to the hitter, such as the ability to hit ball away, the ability to hit ball with bat, . . . and the like, and the parameter items related to the strategy and the like, such as the bunting ability, the base stealing ability . . . and the like. It should be noted that the parameter value, which is set for each of the parameter items, is a numerical value of any one of the range from 1 to 10, when 10 is the full points.

Additionally, in addition to the above-described character-specific ability database (DB1), the system memory 22 stores, as a data table, various kinds of reference data and the like which are set in advance for the game execution control program to control the proceeding of the game. As for such reference data, for example, parameters (hereinafter referred to as “the condition setting parameters”) are stored for performing a process of changing the parameter values with respect to the various kinds of parameter items, which indicate the ability of the player and are set by the character-specific ability database (DB1), for each game (play) played by the game player.

As for the condition setting parameters, for example, levels such as “Hot”, “Good”, “Normal”, “Bad”, and “Slump” are set as five steps of biorhythms for setting the conditions of the players for each game. Additionally, a process is performed which increases or decreases, based on the condition setting parameters, the ability value of the player corresponding to the player card 11, who is registered as an outing player of the game by reading the player card 11, that is, the parameter value of a specific parameter item which is set by the character-specific ability database (DB1).

The process of increasing or decreasing the parameter value is performed such that, at the time when the game player ends an operation of making the player cards 11 read as the outing players of the game, one level is randomly selected from the above-described five steps of biorhythms by a random number generating means for each of the players (player identification information), and based on the selected biorhythm, for example, the parameter value of “ability to hit ball away” among the parameter items, which are set in the character-specific ability database (DB1), is increased or decreased by a predetermined percentage (%) which is set in advance. Additionally, the level of the biorhythm selected for each of the players is displayed on the touch panel 6, so as to notify it to the game player. In this manner, it is possible to vary the ability value of the player who plays in the game, for each game played by the game player. Hence, it is possible to perform a variety of controls of the game. At the same time, it is necessary for the game player to organize the outing players in consideration of the level of the biorhythm of each of the players for each game. Therefore, it is possible to make the game player highly interested in the team organization.

In addition, a parameter related to “motivation” may be further set as the condition setting parameters. The parameter related to the “motivation” performs a process of setting the motivation high when “the player is registered at the best fielding position”, when “registered in the best hitting order” for each game, and when a high motivation is set, setting the above-described level of the biorhythm to, for example, one-level higher.

The method is adopted which stores the game execution control program controlling the execution of the above-described game, the database, and the like in the storage medium 33 such as a CD-ROM or a DVD-ROM or the like as mentioned above, and, when the power of the game device 1 is turned ON, reads the game execution control program, the database, and the like which are stored in the storage medium. However, a method may be adopted which stores in advance the above-described game execution control program and the like in a ROM connected to the bus line 24.

### [Structure of Game Execution Control Program and Game Control of One Game]

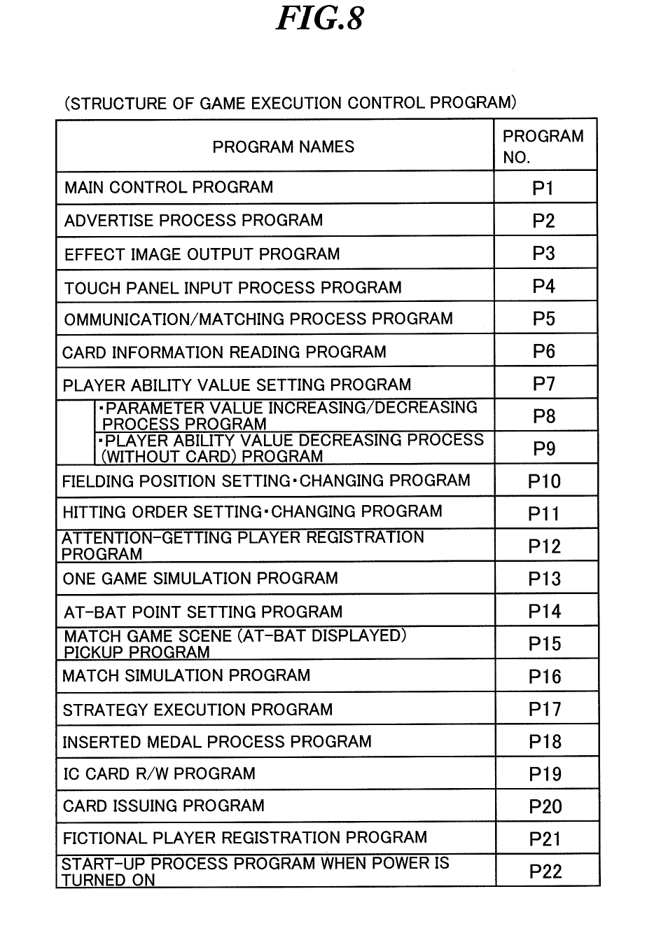

FIG. 8 shows a structure of the game execution control program stored in the system memory 22 for the game device 1 to control the execution of the game. Among the various kinds of programs shown in FIG. 8, a main control program P1 is a main program for generally controlling the control of the game execution. A card information reading program P6, which serves as the card information reading means, is a program which performs a process of controlling the imaging means 13a, such as a image sensor or the like, so as to read the bar-code (BC) (card information) recorded on the above-described player cards 11, storing the image (picture image) data of the read bar-code (BC) in the system memory 22, and analyzing and converting the stored image data into the player identification information represented by digital information.

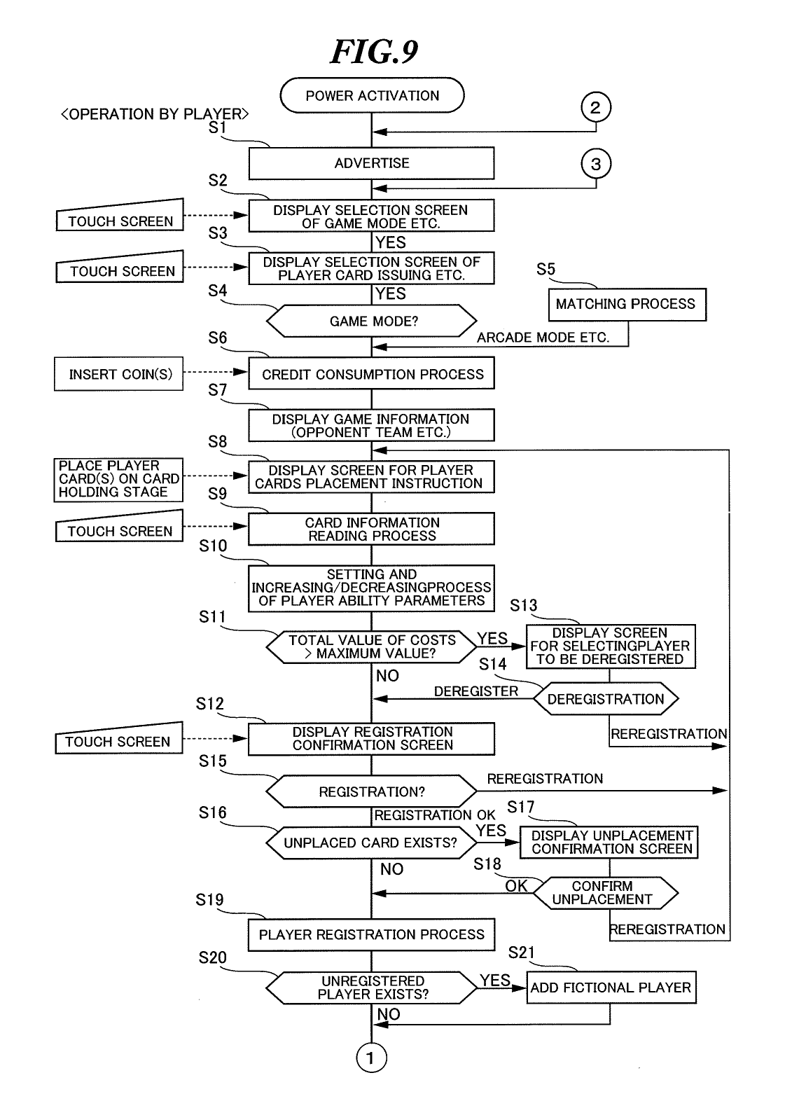

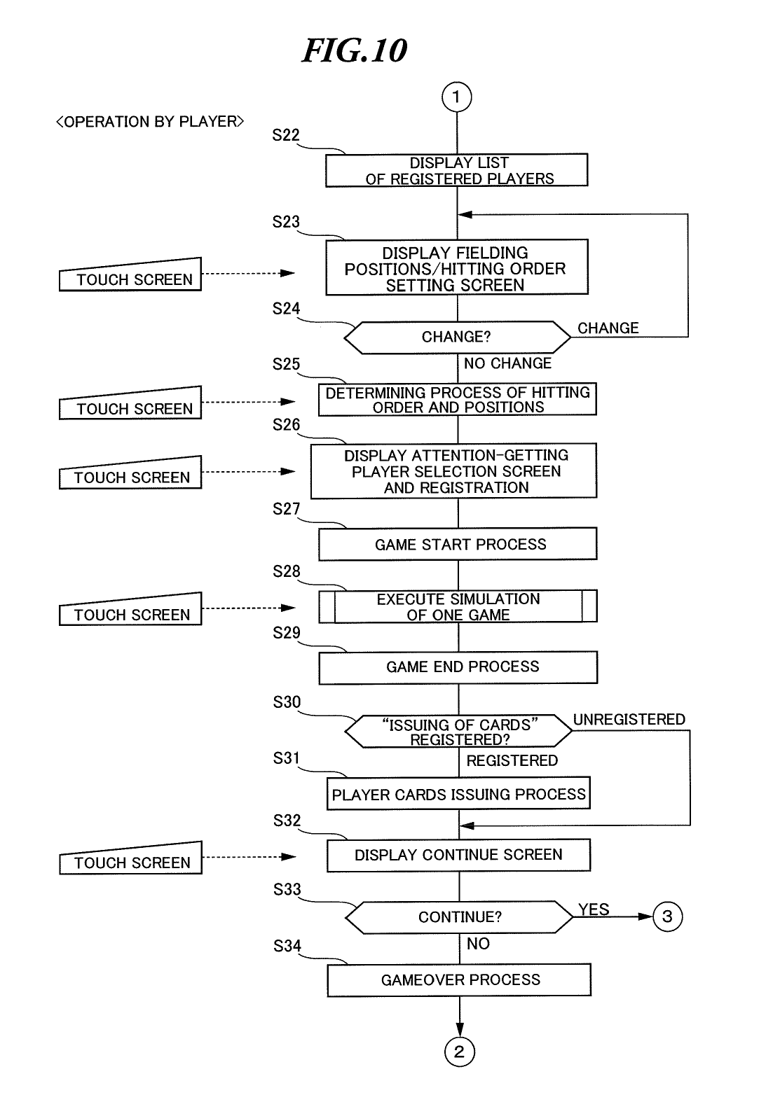

Sequentially, a description is given of a procedure for controlling the game execution of one game by the game execution control program shown in FIG. 8. FIG. 9 through FIG. 11 are flowcharts showing, when the main control program P1 controls the game execution of one game, an example of the flow of the control. Hereinafter, the flow of the control of the one game is described for each process step shown in FIG. 9 through FIG. 11.

It should be noted that, as mentioned above, when the power of the game device 1 is turned ON and the IPL stored in the boot ROM 25 is activated, the game execution control program P1 stored in the optical disc 33 is loaded to the system memory 22. Additionally, by storing in advance, in the optical disc 33, various kinds of image data, video data, and audio and sound effect data, these data are also loaded to the graphic memory 34 or the sound memory 37 by the start-up process program P20 when the power is turned ON.

### (Step S1)

The main control program P1 activates an advertise process program P2 so as to perform an advertising process. The advertising process displays, on the touch panel 6, for example, actual video of a baseball game, a demonstration image explaining an operation method for playing the game, and various kinds of information which is read when the game player inserts IC card 18, owned by the game player, into the IC card R/W device 17, until an input signal is input since the game player inserts coin (s) for performing one game, inserts the IC card 18 into the IC card R/W device 17, or touches the touch panel 6. The various kinds of information refer to wins/losses as the results of playing the games by the game player, the scores (a batting average, home runs, . . . ) of each of the players, and the like of the team to which the player cards 11, owned by the game player, belong.

### (Step S2)

A process is performed which displays, on the touch panel 6, a game mode selection screen for prompting the game player to select a game mode to be played. When the game player conducts an operation (hereinafter referred to as “the touch operation”) of touching a predetermined area of the touch panel 6 with a finger based on the selection screen, a touch panel input process program P4 performs a process of obtaining information of a selection input caused by the touch operation. The game mode refers to a COM mode where the game player plays the game with the game device 1 (COM team), an arcade mode where, when a plurality of game devices 1 are installed in the arcade, the game player plays a match game with another player in the same arcade, and an Internet mode where the game player plays the game with a game player in another arcade via the Internet.

### (Step S3)

When the one game ends, a process is performed which displays, on the touch panel 6, a player card issuing selection screen for prompting the game player to input whether or not the game player desires issuing of a new player card 11a, and a process is performed which obtains selection information made since the game player performs the touch operation on a predetermined area of the touch panel 6 based on the selection screen. It should be noted that a process is performed which sets a game fee (the number of coins to be inserted) required for one game to be lower in a case where the game player does not desire issuing of the new player card 11a than in a case where the game player desires issuing of the new player card 11a.

### (Step S4)

In the process of step S2, the game mode selected by the game player is determined. As a result of the determination, when the game player selects the arcade mode or the Internet mode, progress is made to step S5. On the other hand, when the COM mode is selected, progress is made to step S6.

### (Step S5)

When the game player selects the arcade mode, a matching program P5 accesses the arcade server connected to the in-store LAN 42, so as to confirm whether or not an opponent player is registered by another game player in the same arcade, and, when the opponent player is registered, performs a process for performing a match game with the another game player. Additionally, when the opponent player does not exist, control is performed to play the game in the COM mode. Further, when the game player selects the Internet mode, the matching program P5 accesses a Web server, managing the Internet match game using the game device 1, so as to confirm whether or not the opponent player is registered, and, when the opponent player is registered, performs a process for playing a match game with the game player in another arcade. On the other hand, when the opponent player does not exist in another arcade, a process is performed for playing the game in the COM mode.

It should be noted that the following process steps in the game are described about the control in a case where the game is played in the COM mode.

### (Step S6)

A display is made on the touch panel 6, so as to prompt the game player to insert coin(s) required for playing one game in a coin insertion opening (not shown in FIG. 1). Then, when a detection sensor detects the coin(s) inserted by the game player, an inserted medal process program P18 determines the number of the coin(s), and when the required number of the inserted coin(s) is confirmed, progress is made to step S7.

### (Step S7)

The game player is then supposed to play a game in the COM mode, and a process is performed which displays, on the touch panel 6 for a predetermined time period, the game information, for example, the team name of the game player, the name of an opponent team, a baseball stadium name and the like.

### (Step S8)

A process is performed which displays, on the touch panel 6, a screen prompting the game player to place the player cards 11 for playing the game on the card holding stages 10 arranged on the field panel 9, and also outputs the audio from the speakers 14 and 15.

Based on an instruction for the team organization, the game player performs the team organization for the game to be played from the player cards 11 which the game player owns. The team organization is performed by, for example, selecting 13 player cards 11 from among the player cards 11 which the game player owns, so that the number of players who can play in the game becomes 13. It should be noted that, among the 13 selected player cards 11, 10 serve as the player cards 11 corresponding to the starting members including a DH player, and the other 3 serve as the player cards 11 corresponding to backup players.

Additionally, when the game player selects the 13 player cards 11, which can be used in the game, the game player inserts each one of the 9 player cards 11, corresponding to the starting players, into the card placing part 12 of the card holding stage 10, which is arranged in the position indicating the fielding position (position) set to the field panel 9, in the raised state as shown in FIG. 2. In this manner, as shown in FIG. 1 (FIG. 2), the player card 11 is placed in the card placing part 12, and held by the card holding stage 10 in the raised state.

As mentioned above, since the player card 11 is placed in the card placing part 12 of the card holding stage 10 in the raised state, it is easy for the game player to confirm the player name and the fielding position corresponding to the player card 11 held by the card holding stage 10. In addition, since the field panel 9 is positioned above with respect to the provision position of the touch panel 6, which is provided in the housing 2, each card holding stage 10 does not interrupt the touch operation on the touch panel 6 by the game player who plays the game. Further, since the player card is placed and held by the card holding stage 10 in the raised state as mentioned above, it is possible to reduce the surface area of the field panel 9.

Additionally, the opening 12a is provided in the lower end portion of the card placing part 12, and the opening 12a communicates with the inside of the sensor housing part 13 of the card holding stage 10. Hence, it is possible for the imaging means 13a, which is housed in the sensor housing part 13, to image the bar-code BC representing the card information (player identification information) recorded on the lower part of the back surface of the card 11 inserted into the card placing part 12.

### (Step S9)

When the game player performs the touch operation on the touch panel 9, and information related to a reading instruction of the card information is input to the control device 20, the main control program P1 activates the card information reading program P6. Thus, the card information reading program P6 performs a process of sequentially reading and storing, in the system memory 22, the image data of the bar-code (BC) recorded on the back surface of the player card 11 imaged by the imaging means 13a provided in each card holding stage 10. Then, the card information reading program P6 performs a process of analyzing the image data of the bar-code (BC) stored in the system memory 22, converting the player identification information represented by the bar-code (BC) into digital information (identification number), and storing the converted player identification information in the system memory 22.

Further, it is set in advance which position of the fielding positions, the DH (designated hitter), and backup players, which are set to field panel 9, corresponds to each of the imaging means 13a arranged in the plurality of card holding stage 10. In other words, a data table is registered in the system memory 22 which associates the identification information of the position and an address location of the system memory 22 to which the imaged data from the imaging means 13a is input.

In this manner, in the reading process of the card information (bar-code (BC)) of step S9, it is possible to obtain, with respect to the player card 11 held by the card holding stage 10, the player identification information associated with the position of the character, such as the fielding position, the DH (designated hitter), and the backup player, corresponding to the player card 11. That is, it is possible to obtain the player identification information associated with position information indicating the position of the player corresponding to the player card 11, with respect to the team which is organized by the game player to start playing the game. Additionally, the player identification information obtained for each position is stored in a team organization data storing area, which is set in the system memory 22.

Hence, the player identification information associated with the position information of the nine fielding positions and one DH (designated hitter) is registered as the player identification information of the players corresponding to the starting members of the team for which the game player starts playing.

### (Step S10)

By step S9, a team organization data table, which stores the player ability values for each player identification information, is created and stored in the system memory 22 by referring to the character-specific ability database (DB1) with respect to the player identification information stored in the system memory 22. Sequentially, a parameter value increasing/decreasing process program P8, serving as a parameter value increasing/decreasing process means, performs a process of obtaining the values of the above-described condition setting parameters for each player identification information stored in the team organization data table, and increasing or decreasing, based on the obtained parameter value, a specific parameter value among the parameter items indicating the ability of the player.

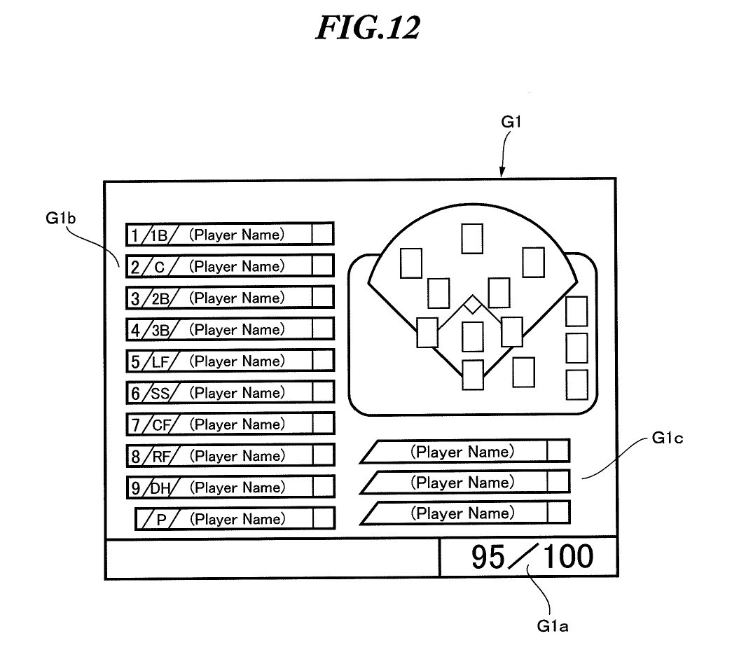

Sequentially, a process is performed which calculates a total value of the “costs” for each player identification information stored in the team organization data table. Additionally, in order to inform the game player of the calculated total value of the costs, for example, a process is performed which makes a display in an area Gla of a display screen G1 of the touch panel 6 as shown in FIG. 12. Further, the area G1a displays the maximum value of the costs in the game and the calculated total value of the costs. The example shown in FIG. 12 indicates that the maximum value of the costs in the game (play) is “100”, and the calculated total value of the costs is “95”.

### (Step S11) (Step S12) (Step S13) (Step S14)

It is determined whether or not the total value of the costs exceeds the maximum value in the game. As a result of the determination, when the total value of the costs does not exceed the maximum value, progress is made to step S12, where a process is performed which displays, on the touch panel 6, a registration confirmation screen (the screen G1 shown in FIG. 12) of the players.

On the other hand, when the total value of the costs exceeds the maximum value, progress is made to step S13, where a process is performed which displays, on the touch panel 6, a screen for prompting the game player to select whether to deregister the players (player cards 11) read in the process of step S9, or to reregister the player cards. Additionally, in step S14, when the game player selects deregistration, progress is made to step S12, and when the game payer selects reregistration of the players by performing the reading of the new player card 11 again, a return is made to step S8, and the game player performs an operation of replacing one or a plurality of player cards 11 placed in the card holding stages 10 with other player cards.

It should be noted that a process is performed which sets a predetermined value (for example, “40”) as an initial value for the maximum value of the costs for each game, and increases the initial value in accordance with the number of times of playing games stored in the IC card 18. In this manner, when the game player does not simply perform organizing of the team by collecting the player cards of the players with high abilities, but performs organizing of the team which is strongest within the maximum value of the costs, it is possible to play a game where the strategy of the game is more improved.

### (Step S15)

When an input signal related to “register” is obtained through the touch operation by the game player based on the registration confirmation screen of the players displayed on the touch panel 6 in the process of step S12, progress is made to the next step S16, and when an input signal related to “reregister” is obtained, a process which returns to step S8 is performed.

### (Step S16) (Step S17)

In step S16, it is determined whether or not there is an unregistered player card for the player cards registered by the game player by placing the player cards 11 on the card holding stages 10, that is, un unplaced player card of the player cards 11 which is not placed in the card holding stage 10 by the game player. It becomes possible to perform the determination by determining whether or not data related to normal player identification information is stored with respect to the player identification information stored in the team organization data table.

As a result of the determination, when the unplaced player card does not exist, progress is made to step S19. On the other hand, when the unplaced player card exists, progress is made to step S17, where a process is performed which displays, on the touch panel 6, a screen confirming whether or not the game player places the player card 11 in the card holding stage 10, corresponding to the position where the player card is not placed. Additionally, when an input signal related to “reregister” is obtained from the confirmation screen in step S18, a return is made to step S8, and when an input signal related to “unplacement acknowledged” is obtained, progress is made to step S19.

### (Step S19)

A process is performed which determines information such as the player identification information stored in the team organization data table of the system memory 22 as the player cards 11 to be used in the game to be played, that is, as the player identification information, and a process is performed which associates and stores, as an outing player registration data table which is set to the system memory 22, these player identification information and the like with the information related to the fielding positions (positions).

### (Step S20)

It is determined whether or not a position exists, to which the player identification information is not stored, with respect to the information related to the positions in the outing player registration data table, which is stored in the system memory 22 in the process of step S19, that is, it is determined whether or not an unregistered player exists. As a result of the determination, when the unregistered player exists, progress is made to step S21, where a registration process of a fictional player is performed. On the other hand, when the player identification information is stored for all of the positions, progress is made to step S22.

### (Step S21)

With respect to the position for which it is determined in the process of step S20 that the player identification information is not registered, a process is performed which stores, by a fictional player adding program P21, the player identification information related to the fictional player in the outing player registration data table of the system memory 22 such that the player identification information corresponds to the position. With this process, the game player can play the game, even if the game player does not carry the player card. It should be noted that, in order to perform the process of step S21, a fictional-player-specific ability database, related to the number of players corresponding to one team, is registered in the system memory 22 in advance. The data structure of the fictional-player-specific ability database is the same as the structure of the character-specific ability database (DB1).

### (Step S22)

Touch panel 6 displays list information of the team organization related to the player identification information (including the player names) and the like for each position stored in the outing player registration data table of the system memory 22. The list information of the team organization is displayed as, for example, the display screen G1 as shown in FIG. 12. The display screen G1 displays the hitting order of the starting players, their positions (“1B” indicates that the position is the first base), and the player names in a display area Gib, and the player names of the backup players in a display area Glc.

### (Step S23) (Step S24)

The display screen G1 displayed in the process of step S22 allows changing of the hitting order and the positions through the touch operation on the touch panel 6 by the game player. Additionally, when the game player desires the changing, the game player performs an operation of changing one or both of the hitting order and the positions through the touch operation. Based on this operation, a hitting order setting•changing program P10 and a fielding position setting•changing program P11 perform processes of changing the hitting order and the fielding positions. In this operation, when the touch operation is performed on a “position change” area displayed on the touch panel 6, a return is made to step S22, and the position can be changed by performing the touch operation on the display area Glb. The touch operation similar to this is also performed with respect to the changing of the hitting order.

### (Step S25)

A process is performed which makes a final decision with respect to the hitting order and the positions. In this process, when the game player performs the changing operation of the hitting order or the positions in the process of the above-described step S23 and step S24, a process is performed which reregisters information obtained by the changing operation in the outing player registration data table, and performs a process which finally decides as the outing players of the game to be played.

### (Step S26)

An attention-getting player registration program P12 performs a process which displays, on the touch panel 6, an attention-getting player selection screen for selecting an attention-getting player for the game among from the players who are registered in the outing player registration data table. When the game player touches a player name displayed on the attention-getting player selection screen, the attention-getting player registration program P12 performs a process of storing, in the system memory 22, the player identification information corresponding to the player as an attention-getting player of the game. Further, the main control program P1 performs a process which renders the player registered as the attention-getting player of the game to readily appear in the match game scene (specific scene) where a simulation of the battle between the pitcher and the hitter, which is described later, is executed.

### (Step S27)

Main control program P1 activates an effect image output program P3, so as to output an effect video of game start on the touch panel 6, and to output its sound and sound effects to the speakers 14 and 15 for a predetermined time period. Thereafter, progress is made to step S28, where control of game execution of one game is performed as play ball.

### (Step S28)

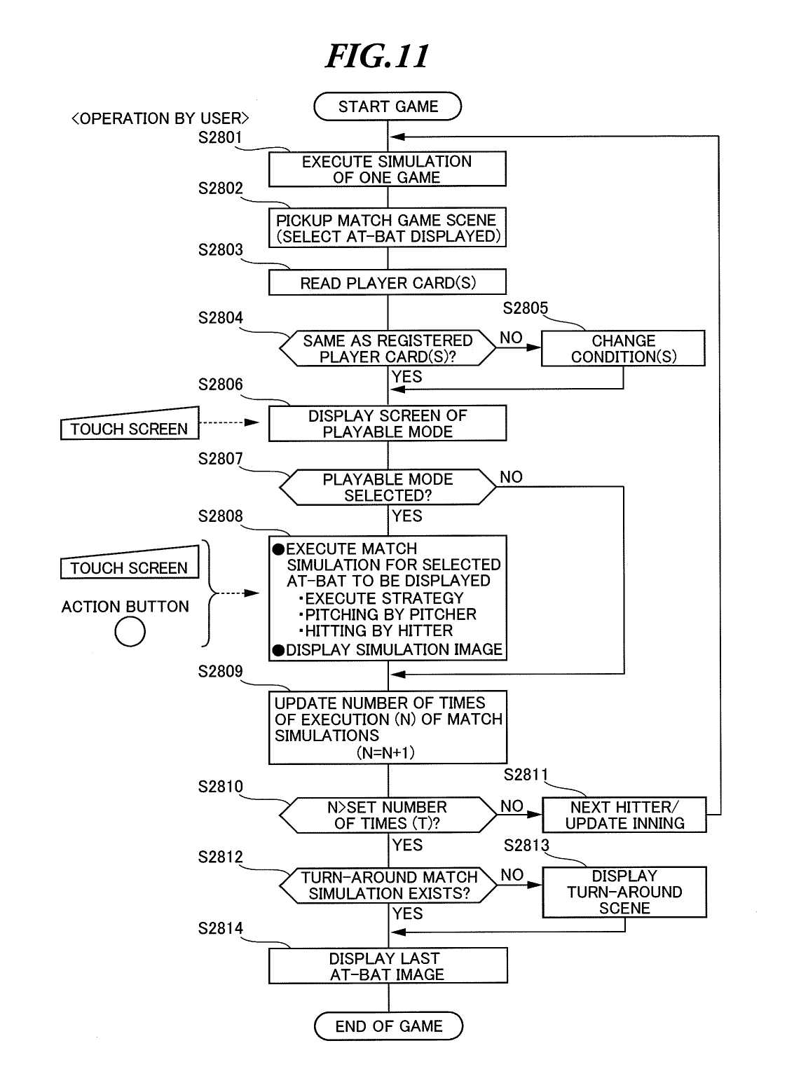

In step S28, as mentioned above, control of execution of one baseball game is performed between the COM team registered in advance in the control device 1 and the team organized by the game player based on the information read from the card information recorded on the player cards 11, which are placed in the card holding stage 10 in the raised state by the game player. A specific example of a procedure for controlling the execution of the match game is shown in FIG. 11, the processing of which is described later.

### (Step S29)

When the one game ends by executing the process of step S28, a process is performed which outputs information related to a game result on the touch panel 6, and outputs its sound and sound effects to the speakers 14 and 15 for a predetermined time period as a process of ending the game. Additionally, a process is performed which records the information related to the play result of the game on the IC card 18 by an IC card R/W program P19.

### (Step S30) (Step S31)

In a process of step S30, based on the above-described process of step S3, it is determined whether or not the information, indicating that the game player desires issuing of the new player card 11a, is registered (stored) in the system memory 22. Additionally, when the information, indicating that the issuing of the new player card 11a is desired, is registered (stored), progress is made to step S31, where a card issuing program P20 performs a process of issuing one player card 11a to the game player. It should be noted that the new player card 11a, which is issued to the game player, can be used when the game player plays the next game.

### (Step S32) (Step S33) (Step S34)

In step S32, a process is performed which displays, on the touch panel 6, a continue screen for inquiring whether or not the game player sequentially plays (continues) the next game. Additionally, when it is determined by step S33 that input information based on the touch operation by the game player selects continuing, control is performed to return to the above-described process of step S2, and control of game execution is performed for the next one game. On the other hand, when the game player does not select continuing, progress is made to step S34, where a process is performed as a game over process which displays, on the touch panel 6, information related to ending of the game, and performs control to return to the above-described process of step S1.

Based on the processes of the above-described steps S1-S34, the main control program P1 performs control of game execution of the one game (one match).

Subsequently, a description is given of processing of step S28, where the control of game execution of one game is performed, for each step of a flowchart shown in FIG. 11.

### (Step S2801)

A one game simulation program 13, serving as a simulation means, executes a simulation of one baseball game, that is, a simulation of the battles between the hitters and the pitcher(s) for each inning from the top half of the first inning to the bottom half of the ninth inning. The execution of the one game simulation is performed based on the information related to the hitting order of the starting players recorded in the outing player registration data table of the system memory 22, the parameter values indicating the various ability values of the players, and the ability parameter values of each player in the COM team.

Additionally, a one game simulation program P13 performs a process of storing, in the system memory 22, data of the result of the execution of the simulation of each inning from the top half of the first inning to the bottom half of the ninth inning, and, at the same time, evaluating the simulation result of all of the innings based on a predetermined evaluation standard, and setting (giving) the evaluation as an at-bat points for each at-bat. The evaluation for each at-bat is performed by an at-bat point setting program P14. Further, the processing of the at-bat point setting program P14 serves as an evaluation means for calculating evaluation information for each appearance scene of the character based on the simulation result of one game.

Further, in the method of giving the above-described at-bat points by the at-bat point setting program P14, for example, a process is performed which obtains the next first to fifth at-bat points for each at-bat, and sets the total value of these obtained first to fifth at-bat points to the at-bat points of the at-bat.

### (1) First At-Bat Points

In the battle between each hitter and the pitcher, first at-bat points are set in accordance with the cost values of the hitter and the pitcher. For example, when the cost value of the hitter is “8”, “30 points” is given as the at-bat points, and when the cost value of the pitcher is “8”, “10 points” is given as the at-bat points. The total value of these at-bat points of the hitter and the pitcher is processed assuming that the first at-bat points occur.

### (2) Second At-Bat Points

Second at-bat points occur in accordance with the status of a runner in the at-bat. For example, “30 points” is given when no runner exists, and “8 points” is given when runners exist on the first and second bases.

### (3) Third At-Bat Points

Third at-bat points occur in accordance with the difference between the points of both teams in the at-bat. For example, “30 points” in case of even score, “25 points” in a case where the difference is one point, and the points of the third at-bat points which occur are decreased as the difference in points is increased.

### (4) Fourth At-Bat Points

Fourth at-bat points occur in accordance with the number of inning of the at-bat. For example, “1 point” for the first inning, and “9 points” for the ninth inning.

### (5) Fifth At-Bat Points

For example, “5 points” is given when the player who is registered as the attention-getting player in the above-described step S26 is at-bat.

### (Step S2802)

A match game scene pickup program P15 performs, based on the at-bat points of each at-bat obtained in the process of step S2801, a process of sequentially extracting at-bats for the number of times obtained by subtracting the number of times of playing (N) from a predetermined number of times (T), which are described later, from the at-bat to which the highest at-bat points are given, and selecting, from among them, an at-bat at the time closest to when the game is started. Additionally, the processing of the match game scene pickup program P15 serves as a selection means for selecting, from among appearance scenes of the character(s), a match game scene which allows the operation of the character(s) by the operation means.

Hereinafter, the at-bat selected by the selection means is referred to as “the match game scene (specific scene)”. The higher the at-bat points of the at-bat is, a scene is more likely to be shown where there is a chance for one of the teams in the battle between the hitter and the pitcher, that is, an exciting scene in the game. Further, the main control program P1 displays the game development until the selected scene in a short period of time by, for example, performing a fast-forward display, displaying only the progress of scores or the like, so as to prevent the game player from waiting.

In addition, as described later, when the game player operates the operation means to operate the character, serving as the hitter or the pitcher, displayed on the touch panel 6, the simulation of the battle between the hitter and the pitcher is executed based on control by a match simulation program P16 with respect to the selected “match game scene”. Further, the processing of the match simulation program P16 serves as a specific scene simulation means.

### (Step S2803) (Step S2804) (Step S2805)

In step S2803, a process is performed which activates the card information reading program. P6, so as to read the player card 11 held by each card holding stage 10. Additionally, in the process of step S2804, a process is performed which determines whether or not the player identification information, which is read, is already registered in the outing player registration data table stored in the system memory 22. On this occasion, it is determined at the same time whether the player card 11 is placed in the card holding stage 11 at this moment. The processes of the step S2803 to S2804 are processes for finding that the game player uses the player card 11 with high ability only in the player registration of the player card 11 placed in the card holding stage 10, and serve as a card placement reconfirmation means. In other words, there is an effect of preventing the game player from losing the motivation for purchasing the player card 11, since if it is possible to use the player card 11 with high ability only in the player registration, and to immediately use the player card 11 in another game device, for example, it becomes possible to play the game while sharing one player card 11 between friends.

In the process of step S2804, when it is determined that the player identification information corresponding to the player card 11 which is read in the process of step S2803 is not registered in the outing player registration data table, or when it is determined that the player card 11 is not placed in the card holding stage 11, the process of step S2805 is performed.

The process of step S2805 performs, by a player ability value decreasing process program P9, a process of decreasing the ability parameter value (reducing points) registered in the outing player registration data table, with respect to the player identification information of the position, for which it is determined in the process of step S2804 that the player identification information corresponding to the player card 11 which is read in the process of step S2803 is not registered in the outing player registration data table, or that the player card 11 is not placed in the card holding stage 11. In the point reduction process, a process is performed which changes the value of the above-described condition setting parameter such that the parameter value of the specific ability parameter item is decreased to a maximum extent.

### (Step S2806)

The main control program P1 performs a process of setting, to a playable mode, the control of the game in the match game scene selected by the match game scene pickup program P15, and displaying, on the touch panel 6, a playable mode selection screen for prompting the game player to select whether or not to execute the playable mode. The playable mode refers to a mode where, in the match game scene (specific scene) selected in the process of step S2802, the pitcher or the hitter is controlled through the operation by the game player, that is, the game player is allowed to operate the movement of the pitcher or the hitter. When the execution of the playable mode is selected, the match simulation program P16 performs a process of controlling the movement of the player (character) in the match scene between the pitcher and the hitter, based on the operation by the game player on the action button 19 and the touch panel 6, serving as the operation means, and displaying the game scene on the touch panel 6.

### (Step S2807) (Step S2808)

In the process of step S2807, when the game player selects the execution of the playable mode from the playable mode selection screen, progress is made to the process of step S2808. In step S2808, the match simulation program P16 also allows selection of “execute strategy”, such as “base stealing” or “bunt”, based on the operation on the touch panel by the game player. Additionally, when the game player selects one of “base stealing” and “bunt” from the strategy execution menu, a strategy execution program P17 performs a process of simulating the scene of the selected strategy based on the ability parameter value of the relevant hitter or runner stored in the outing player registration data table, and the ability parameter value of the player such as a catcher of the COM team, and displaying, on the touch panel 6, the strategy execution scene and the result. Further, information of the strategy result is stored in the system memory 22.

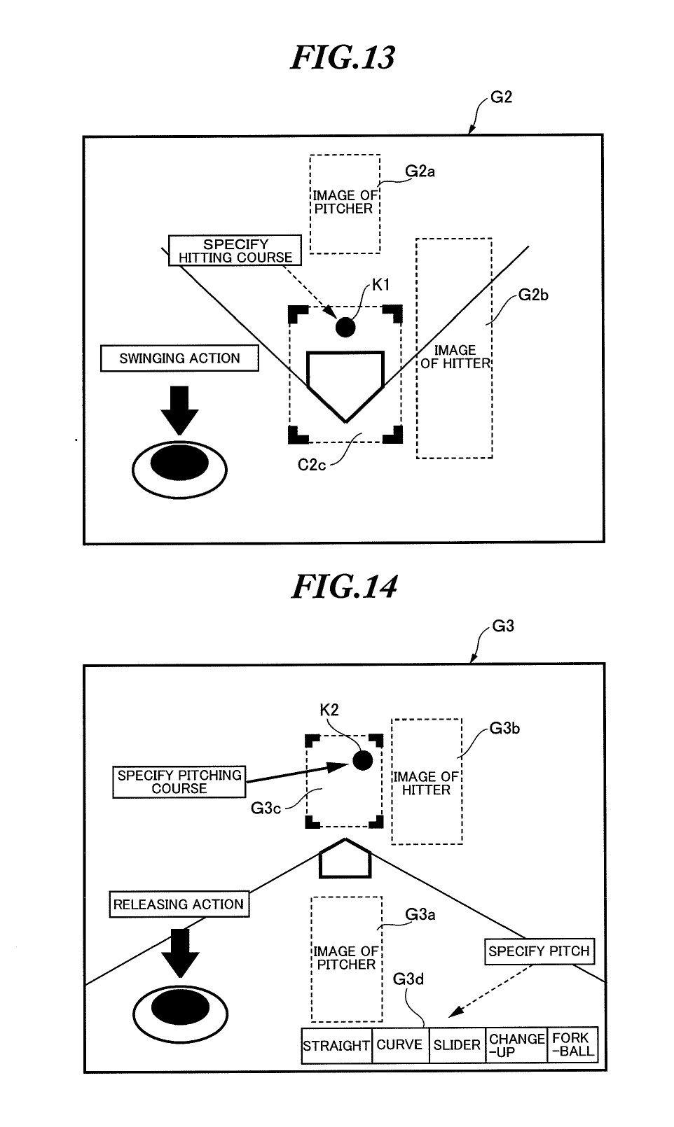

When the selected match game scene is an offence inning of the team of the game player, and when the game player selects playing of a match simulation game between the hitter and the pitcher, the match simulation program P16 displays, for example, a simulation screen G2 where the hitter battles with the pitcher as shown in FIG. 13. In addition, the match simulation program P16 executes the match simulation game between the pitcher and the hitter, based on an image displayed in the simulation screen G2, and an operation by the game player on the action button 19 and the touch panel 6, serving as the operation means.

The simulation screen G2 shown in FIG. 13 displays, in a display area G2a thereof, a moving image of a pitching motion of the pitcher of the opponent team. Additionally, a display area G2b displays a video picture of the hitter who belongs to the team of the game player and appears in the match game scene. Further, the match simulation program P16 executes the match simulation game between the pitcher and the hitter, based on the operation by the game player, in the procedure described in the following (1)-(4), for example.

(1) First, the game player specifies, by the touch operation on the touch panel 6, a “hitting course” to be hit by the hitter in a pitching zone of the pitcher, which is displayed in an area G2c of the simulation screen G2. Based on an operation input signal from the touch panel 6, serving as the operation means, the match simulation program P16 performs control of displaying the position of the “hitting course” specified by the game player with a black circle mark K1 as shown in FIG. 13.

(2) Sequentially, the match simulation program P16 performs a process of displaying, in the display area G2a of the simulation screen G2, a moving image video picture of a pitching motion of the pitcher.

(3) Then, the game player performs an operation of pressing the action button 19, serving as the operation means, by determining the moment at when the hitter should swing a bat, considering the pitching motion of the pitcher displayed in the display area G2a of the simulation screen G2 and the movement display of a ball. When an operation input signal is input from the action button 19, the match simulation program P16 displays a video where the hitter, who is being displayed in the area G2b, swings the bat.

(4) The match simulation program P16 performs a process of determining the timing between the moving position of the ball and the operation input signal which is input from the action button 19, and, when the determined timing matches, determining that the hitter obtains a good result, for example, slugs a home run or hits a single. On the other hand, when it is determined that the timing does not match, a process is performed which determines that the hitter is struck out.

Further, when an inning scene is picked up as the match game scene when the team of the game player is fielding, the match simulation program P16 performs control of displaying a simulation screen G3 as shown in FIG. 14. In addition, a video of the pitching motion of the pitcher corresponding to the team of the game player, a swing video of the hitter of the opponent team, and a zone of a pitching course to be aimed by the pitcher are displayed in a display area G3a, a display area G3b, and a display area G3c of the simulation screen G3, respectively.

Additionally, when performing the simulation game related to the pitching, first, the game player specifies, by the touch operation on the touch panel 6, a “pitching course” to be pitched to the hitter of the opponent team by the pitcher of the team of the game player. In the exemplary screen shown in FIG. 14, the example is shown where the “pitching course” specified by the game player is displayed by a black circle mark K2. On this occasion, the game player is allowed to specify the pitch displayed in a display area G3d by the touch operation on the simulation screen G3.

Sequentially, a moving image video picture of the pitching motion of the pitcher is displayed in the display area Gia. Additionally, the game player presses the action button 19 in accordance with the video of the pitching motion of the pitcher. Further, the match simulation program P16 performs a process of determining the timing when the pitcher releases the ball in the video of the pitching motion, and the timing of the operation input signal which is input from the action button 19, when the determined timings match, determining that the pitcher obtains a good result, that is, strikeout, and when the timings do not match, determining that a single is hit or the like.

### (Step S2809)

The main control program P1 performs a process of adding “1” to an area for counting the number of times of playing (N) the match simulation which is set to the system memory 22. It should be noted that, in the above-described process of step S1, a process is performed which stores “0” as an initial value in the area for counting the number of times of playing (N).

### (Step S2810)

The main control program P1 determines whether or not the number of times of playing (N) exceeds the predetermined number of times (T). As a result of the determination, when not exceeding the number of times (T), progress is made to step S2811, and when exceeding the number of times (T), progress is made to step S2812.

### (Step S2811)

The main control program P1 performs a process of performing control to return to step S2801 by executing a preprocessing for continuing, from the batter following the batter on whom the match simulation is performed in the above-described step S2808, the one simulation game related to the game. The one game simulation program P13 performs again the process of executing the simulation of a scene of each at-bat from the scene of the next at-bat to the bottom half of the ninth inning of the game.

Additionally, in the process of step S2811, information related to the simulation result, for which the match simulation is performed in step S2808, is stored in the system memory 22. The information related to the simulation result is, the inning and the hitting order of the match simulation performed in step S2808, the number of outs as a result of performing the simulation, the runners on-base when the inning is not over, the score, and the like.

### (Step S2812) (Step S2813)

The match simulation game based on the operation by the game player is executed for the “match game scene” for the predetermined number of times (T). Thus, in step S2812, the next determination process is performed. In other words, it is determined whether or not a scene exists where the score is turned around, as a result of executing the match simulation game in the above-described process of step S2808. As a result of the determination, when the scene exists where the scores is turned around, progress is made to step S2813, where an effect process is performed which displays, on the touch panel 6, the scene of “the match game scene” where the turn-around occurs for a predetermined period of time. Then, progress is made to step S2814.

### (Step S2814)

An effect process is performed which displays, on the touch panel 6, a hitting scene of the final hitter of the game for a predetermined period of time, and the execution of the simulation of one game, which is the process of step S28, ends.

As mentioned above, in the present invention, the limitation is set to the number of times of playing the match simulation based on the operation by the game player for one game (play), such that the number of times of playing becomes the predetermined number of times (T), which is set in advance. The predetermined number of times (T) is set to, for example, about six times to eight times. In this manner, the number of times of playing the match simulation is controlled by the above-described processes of steps S2801-S2810 to be the predetermined number of times, and the execution time of one match simulation is controlled to be, for example, about one minute to two minutes. Thus, it is possible to make the game time for one game played by the game player within a predetermined period of time. Hence, it is possible to prevent the game time of the game player from being extremely long.

Additionally, in the above-described embodiment, it is selected whether or not to do the playable mode in the match game scene. However, the playable mode may always be set. In this manner, it is possible to make the game player to associate with the development of the game deeper, and to increase the motivation of the game player for participating in the game.

In the above-described embodiment of the game device 1, the description is given of the example where the position of printing (recording) the bar-code, indicating the card information, on the player card 11 is in the lower end portion of the back surface of the player card 11. However, an appropriate position may be used as long as the player card 11 can be read in the raised state. For example, the bar-code may be printed in the lower end portion of the front surface of the player card 11, or may be printed on one or both of the left and right end portions of the front surface, the back surface, or the both surfaces of the player card 11. Further, the description is given of the example of the touch panel where the operation means which can obtain the input information when the screen is touched is integrally formed with a display means displaying the game image and the like. However, the present invention may be a game device separately including a dedicated touch panel for obtaining the input information, and the display means for displaying the game image and the like.

Further, the information recorded as the card information may include, in addition to the player identification information of the player corresponding to the player card 11, a part or all of the parameter values related to the parameter items of the player ability shown in FIG. 6. In this case, when recording (printing) the player identification information and a part of the parameter data values of the player ability on the player card 11 by using the bar-code, the recording is made by utilizing one or both of the left and right end portions and the lower end portion of the player card 11.

In addition, when recording (printing) the player identification information and all of the parameter values of the player ability on the player card 11, the amount of the information becomes large. Thus, these information may be recorded in, for example, a two-dimensional code, and the two-dimensional code may be printed on an appropriate position of the back surface of the player card 11. Furthermore, a card incorporating an IC chip or a RFID (Radio Frequency identification) may be used as the player card 11, and an IC-chip reading means may be provided to the card holding stage 10. Additionally, the player card 11 may include a magnetic storage means, and the card holding stage 10 may include a magnetic information reading means.

In addition, the player card 11, on which the identification information such as the bar-code is printed in an end face portion of the lower end of the card, may be placed in the card holding stage 10 in the raised state, and a means may be adopted which reads the bar-code by a reading means such as an image sensor provided in the lower side of the card holding stage 10.

Further, in the above-described embodiment of the present invention, the description is given of the example of the game device to which the baseball game is applied. However, in addition to the baseball game, the game device of the present invention can be applied to the games of sporting events, such as soccer, American football, volleyball, and hockey. In order to play a game intending such a sporting event, the card holding stages are provided in the areas serving as the locations of the positions of players, that is, the defense positions, the offense positions and the like, on the field panel imitating the fields of such sporting events, and the game execution control means includes a program for selecting a highlight scene specific to each of the sporting events, and executing the match simulation game based on the operation by the game player in the selected scene.

### EXPLANATION OF REFERENCE NUMERALS

1: game device
2: housing
3: table part
4: panel part
6: touch panel
7: liquid crystal display device
9: field panel
10, 10a, 10b, 10c, . . . : card holding stage
11, 11a, 11b, 11c, . . . : card (player card)
13a: imaging means
20: control device
21: CPU
DB1: character-specific ability database
BC: bar-code (card information)
P4: touch panel input process program
P6: card information reading program
P8: parameter value increasing/decreasing process program
P9: player ability point reduction process program
P13: one game simulation program
P14: at-bat point setting program
P15: match game pickup program
P16: match simulation program

1. A game device including a game execution control means for controlling progress of a game in accordance with card information read from a card and an operation input signal input from an operation means including a touch panel, the game device comprising:
a field panel provided above the touch panel and imitating a game field;
a plurality of card holding stages that are arranged in respective positions on the field panel indicating positions of a plurality of characters in the game field and hold the card in a raised state; and
a card information reading means for reading card information recorded on the card held by the card holding stages,
wherein the game execution control means controls the progress of the game, based on the card information read by the card information reading means.

2. The game device according to claim 1, wherein the game execution control means includes:
a simulation means for controlling, based on the card information read by the card information reading means, progress of a game by making a character corresponding to the card information participate therein, and simulating a game development from a start until an end of the game;
an evaluation means for calculating evaluation information for each appearance scene of the character in a simulation result;
a selection means for selecting, based on the evaluation information, a specific scene that allows an operation of the character by the operation means from the appearance scene of the character; and
a specific scene simulation means for simulating a game development in a specific scene based on an operation input signal from the operation means in the specific scene selected by the selection means,
wherein the simulation means simulates again a game development from a specific scene until an end of a game, based on a simulation result by the specific scene simulation means.

3. The game device according to claim 2, wherein the game execution control means includes:
a means for controlling a number of times of execution of the specific scene simulation means to be a predetermined number of times that is set in advance.

4. The game device according to any one of claim 1 to claim 3, wherein the game execution control means includes:
a character-specific ability database that is information stored in a storage means for each character corresponding to the card information, and registers in advance an ability value of the character with respect to a game execution;
a condition setting parameter that increases or decreases the ability value of the character; and
a parameter value increasing/decreasing process means for increasing or decreasing, based on the condition setting parameter, the ability value in the game of the character corresponding to the card information read by the card information reading means.

5. The game device according to claim 4, wherein the game execution control means includes a card placement reconfirmation means for determining, before execution of the specific scene simulation means, whether or not the card, corresponding to the card information read by the card information reading means, is held by the card holding stage, and
the parameter value increasing/decreasing means decreases the condition of a character corresponding to the card that is determined, by the card placement reconfirmation means, as not being held by the card holding stage.

6. A game control method in a game device including a storage means, an operation means including a touch panel, a field panel imitating a game field, a plurality of card holding stages that are arranged in respective positions on the field panel indicating positions of a plurality of characters on the game field and hold a card in a raised state, a card information reading means for reading the card information recorded on the card held by the card holding stage, and a game execution control means for controlling progress of a game, the game control method comprising:
a card information reading step for causing a game execution control means to read and store, in the storage means, the card information of the card held by the card holding stage; and
a game execution control step for controlling progress of a game in accordance with the card information stored in the storage means in the card information reading step and an operation input signal input from the operation means including the touch panel.

7. The game control method according to claim 6, wherein a game execution control means includes:
a simulation step for simulating, based on the card information read by the card information reading step, a game development from a start until an end of a game in which a character corresponding to the card information participates;
an evaluation step for calculating evaluation information for each appearance scene of the character in a result of the simulation step;
a selection step for selecting, based on the evaluation information calculated in the evaluation step, a specific scene that allows an operation of the character by the operation means from the appearance scene of the character; and
a specific scene simulation step for simulating a game development in the specific scene based on an operation input signal from the operation means in the specific scene selected in the selection step,
wherein the simulation step simulates again a game development from a specific scene until an end of a game, based on a simulation result in the specific scene simulation step.

8. The game control method according to claim 7, wherein a number of times of execution of the specific scene simulation step is controlled to be a predetermined number of times that is set in advance.

9. The game control method according to any one of claim 6 to claim 8, wherein the game execution control means executes: a character-specific ability database that is information stored in the storage means for each character corresponding to the card information, and registers in advance an ability value of the character with respect to a game execution; a condition setting parameter that increases or decreases the ability value of the character; and a parameter value increasing/decreasing process step for increasing or decreasing, based on the condition setting parameter, the ability value in the game of the character corresponding to the card information read by the card information reading means.

10. The game control method according to claim 9, wherein the game execution control means executes a card placement reconfirmation step for determining, before execution of the specific scene simulation step, whether or not the card, corresponding to the card information read by the card information reading means, is held by the card holding stage, and
the parameter value increasing/decreasing step decreases the condition of a character corresponding to the card that is determined, by the card placement reconfirmation step, as not being held by the card holding stage.
